(19) United States
(12) Patent Application Publication
(10) Pub. No.: US 2014/0161020 A1
(43) Pub. Date: Jun. 12, 2014

(54) DEVICE AND METHOD FOR SUPPORTING CONTINUITY OF MBMS

(71) Applicants: Myung Cheul Jung, Seoul (KR); Ki Bum Kwon, Seoul (KR); Jae Hyun Ahn, Seoul (KR)

(72) Inventors: Myung Cheul Jung, Seoul (KR); Ki Bum Kwon, Seoul (KR); Jae Hyun Ahn, Seoul (KR)

(73) Assignee: Pantech Co., Ltd., Seoul (KR)

(21) Appl. No.: 14/232,837

(22) PCT Filed: Aug. 13, 2012
(86) PCT No.: PCT/KR2012/006456

§ 371 Date: Jan. 14, 2014

(30) Foreign Application Priority Data
Aug. 17, 2011 (KR) 10-2011-0081868

(51) Int. Cl. H04W 72/00; H04W 48/20; H04W 36/02

(52) U.S. Cl. CPC H04W 72/005; H04W 36/026; H04W 48/20
USPC 370/312

(57) ABSTRACT

The present invention relates to a device and method for transmitting control information about an MBMS service. The present specification discloses a method for receiving control information about an MBMS service performed by a terminal, the method comprising the steps of: receiving, from a serving cell, MBMS current state information of a target cell adjacent to the serving cell via a first broadcast channel; monitoring a frequency of the target cell on the basis of an MBMS frequency list contained in the MBMS current state information of the target cell; performing cell reselection for selecting the target cell; and receiving the MBMS service from the target cell. According to the present invention, the terminal can pre-recognize, in the serving cell, information on a frequency at which an MBMS is provided in the adjacent cell and a type of the MBMS service.

### CROSS-REFERENCE TO RELATED APPLICATIONS

This application is the National Stage Entry of International Application PCT/KR2012/006456, filed on Aug. 13, 2012, and claims priority from and the benefit of Korean Patent Application No. 10-2011-0081868, filed on Aug. 17, 2011, all of which are incorporated herein by reference in their entireties for all purposes as if fully set forth herein.

### BACKGROUND

1. Field

The present invention concerns wireless communications, and more specifically, to a transmission apparatus and method of control information regarding an MBMS service.

2. Discussion of the Background

The “cellular” has been introduced for addressing the restrictions in service area, frequency, and enrollment capacity. This scheme adopts, instead of a single, high-power base station, multiple low-power base stations for offering call coverage. In other words, a mobile communication service area is split into a number of small cells, and different frequencies are assigned to two cells adjacent to each other while the same frequency is applied to two cells that are positioned far away from each other so that no interference arises between the two cells. By doing so, the frequency can be spatially reused.

The term “handover” or “handoff” refers to a function in which, as a user equipment (UE) comes off a current communication service area (hereinafter, “source cell”) and enters into an adjacent communication service area (hereinafter, “target cell”), the UE is automatically tuned with a new traffic channel of the target cell, and thus, the UE's call remains connected. In other words, a UE that is on in communication with a specific base station (hereinafter, “source base station”), if the signal from the source base station weakens, is rendered linked to a neighboring base station (hereinafter, “target base station”). Upon handover, a call disconnection may occur as the UE moves to the neighbor cell.

The MBMS (Multimedia Broadcast/Multicast Service), similar to the existing CBS (Cell Broadcast Service), simultaneously transmits data packets to multiple users. However, in contrast to the CBS that is a low-speed, message-based service, the MBMS targets high-speed, multimedia data transmission. Further, the CBS is not based on IP (internet protocol), but the MBMS is based on the IP multicast. According to the MBMS, in case a predetermined level of users are present in the same cell, the users may receive the same multimedia data using shared resources (or channels), and thus, the efficiency of radio resources is increased, and the users may make use of multimedia services at low price.

The MBMS uses a common channel to provide multiple UEs with a chance of efficient data reception. With respect to one-service data, a base station, instead of allocating as many dedicated channels as the number of UEs that desire to receive the service, assigns a single common channel in a cell. Since the multiple UEs simultaneously receive the common channel, the efficiency of radio resources is enhanced. When it comes to the MBMS, a UE may receive an MBMS after system information on a corresponding cell. However, since a UE cannot be aware of MBMS information on a neighbor cell, the MBMS service cannot be precisely received by the neighbor cell.

### SUMMARY

An object of the present invention is to provide an apparatus and method that supports service continuity for UEs using an MBMS.

Another object of the present invention is to provide an apparatus and method that transmits MBMS-related information in a neighbor cell.

Still another object of the present invention is to provide an apparatus and method that receives MBMS-related information in a neighbor cell.

Yet still another object of the present invention is to provide an apparatus and method that transmits, via a broadcast channel to a UE, an MBMS frequency list indicating frequencies of neighbor cells and the type of an MBMS service that the UE is interested in.

Yet still another object of the present invention is to provide an apparatus and method that receives, via a broadcast channel to a UE, an MBMS frequency list indicating frequencies of neighbor cells and the type of an MBMS service that the UE is interested in.

According to an aspect of the present invention, a method of receiving control information regarding an MBMS (Multimedia Broadcast Multicast Service) service performed by a UE is provided. The method includes receiving from a serving cell through a first broadcast channel MBMS situation information of a target cell adjacent to the serving cell, monitoring a frequency of the target cell based on an MBMS frequency list included in the MBMS situation information of the target cell, performing cell reselection for selecting the target cell, and receiving an MBMS service from the target cell.

According to another aspect of the present invention, a UE of receiving control information regarding an MBMS service is provided. The UE includes a UE receiving unit that receives from a serving cell through a first broadcast channel MBMS situation information of a target cell and receives an MBMS service in the target cell after reselecting the target cell and a UE processor that monitors a frequency of the target cell based on an MBMS frequency list included in the MBMS situation information of the target cell and performs cell reselection for selecting the target cell.

According to still another aspect of the present invention, a method of transmitting control information regarding an MBMS service performed by a base station is provided. The UE includes transmitting MBMS situation information of a target cell adjacent to a serving cell which a UE camps on to the UE through a first broadcast channel from a serving base station providing a serving cell, transmitting MCCH configuration information to the UE through a second broadcast channel from a target base station providing the target cell, transmitting MCH configuration information to the UE through an MCCH indicated by the MCCH configuration information from the target base station, and transmitting an MBMS service mapped with an MCH indicated by the MCH configuration information from the target base station to the UE.

Since a serving cell may be previously aware of frequency information provided by an MBMS in a neighbor cell and the type of the MBMS service prior to a UE's handover, the MBMS service can be received in the neighbor cell although system information on the neighbor cell is not received or a shift to an RRC connection mode is not done.

### BRIEF DESCRIPTION OF DRAWINGS

FIG. 1 is a block diagram illustrating a wireless communication system to which the present invention applies;

FIG. 2 is a view illustrating more specifically a core network architecture of an MBMS to which the present invention applies;

FIG. 3 illustrates a concept of a service scenario in an MBMS to which the present invention applies;

FIG. 4 illustrates another example of a service scenario in an MBMS to which the present invention applies;

FIG. 5 illustrates another example of a service scenario in an MBMS to which the present invention applies;

FIG. 6 is a concept view illustrating an MBMS carrier arrangement scenario to which the present invention applies;

FIG. 7 is a flowchart illustrating a method of transmitting MBMS situation information regarding a neighbor cell providing an MBMS service according to an embodiment of the present invention;

FIG. 8 is a concept view illustrating an MBMS carrier arrangement scenario to which the present invention applies;

FIG. 9 is another concept view illustrating an MBMS carrier arrangement scenario to which the present invention applies;

FIG. 10 is a flowchart illustrating a method of transmitting MBMS situation information regarding a neighbor cell offering an MBMS service according to another embodiment of the present invention;

FIG. 11 is a flowchart illustrating a UE's operation of receiving MBMS situation information regarding a neighbor cell according to an embodiment of the present invention;

FIG. 12 is a flowchart illustrating the operation of a serving base station transmitting MBMS situation information regarding a neighbor cell according to an embodiment of the present invention;

FIG. 13 is a flowchart illustrating the operation of a target base station transmitting MBMS situation information regarding a neighbor cell according to an embodiment of the present invention; and

FIG. 14 is a block diagram illustrating a UE, a serving base station, and a target base station according to an embodiment of the present invention.

### DETAILED DESCRIPTION OF THE ILLUSTRATED EMBODIMENTS

Hereinafter, some embodiments are described in detail with reference to the accompanying drawings. The same denotations are used to refer to the same elements throughout the drawings. When determined to make the subject matter of the disclosure unclear, the detailed description of known configurations or functions is skipped.

The instant disclosure is oriented towards wireless communication networks, and a task to be done in a wireless communication network may be fulfilled while a system (e.g., a base station) in charge of the corresponding wireless communication network controls the network and transmits data or by a UE that is linked to the corresponding wireless communication network.

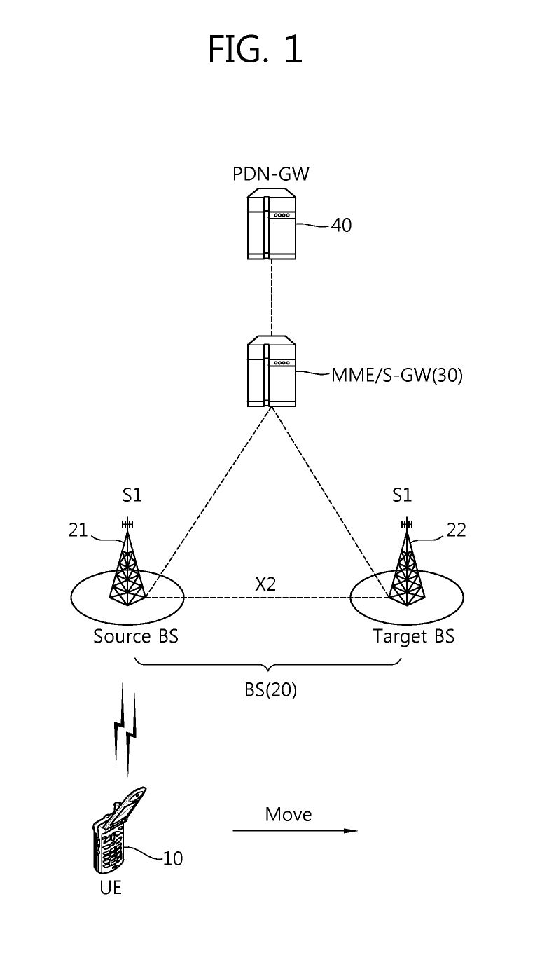

FIG. 1 is a block diagram illustrating a wireless communication system to which the present invention applies. The system may have an E-UMTS (Evolved-Universal Mobile Telecommunications System) network architecture. The E-UMTS system may also be the LTE (Long Term Evolution) or LTE-A (advanced) system. The wireless communication system has a broadened distribution to offer various communication services including voice or packet data services.

Referring to FIG. 1, the E-UTRAN includes at least one base station (BS) 20 that provides a user equipment (UE) with a control plane and a user plane. The UE 10 may be stationary or mobile, and may be referred to by other terms, such as an MS (Mobile Station), an AMS (Advanced MS), a UT (User Terminal), an SS (Subscriber Station), or a wireless device.

The base station 20 generally refers to a station that communicates with the UE 10, and may be referred to by other terms such as an eNodeB (Evolved-NodeB), a BTS (Base Transceiver System), an access point, a femto-eNB, a pico-eNB, a home eNB, or a relay. The base station 20 may provide at least one cell to the UE. The cell may mean a geographical area to in which a communication service is offered or a specific frequency band. The cell may mean a downlink frequency resource and an uplink frequency resource. Or, the cell may mean a combination of a downlink frequency resource and an optional uplink frequency resource. Further, in general case carrier aggregation (CA) is not considered, one cell has a pair of uplink and downlink frequency resources.

An interface for transmission of user traffic or control traffic may be used between base stations 20. The source base station (BS) 21 refers to a base station having a radio bearer currently established with the UE 10, and the target base station (BS) 22 refers to a base station to which the UE 10 is to hand over, disconnecting the radio bearer with the source base station 21.

The base stations 20 may be linked to each other via an X2 interface that is used for exchanging messages between the base stations 20. The base station 20 is linked through an S1 interface to an EPS (Evolved Packet System), more specifically, a mobility management entity (hereinafter, MME)/S-GW (Serving Gateway, 30). The S1 interface supports a many-to-many relation between the base station 20 and the MME/S-GW 30. In order to provide a packet data service to the MME/S-GW 30, a PDN-GW 40 is used. The PDN-GW 40 varies depending on the purpose or service of communication, and a PDN-GW 40 for supporting a specific service can be discovered using APN (Access Point Name) information.

The inter E-UTRAN handover is a basic handover mechanism used for handover between E-UTRAN access networks and consists of X2-based handover and S1-based handover. The X2-based handover is used when the UE hands over from the source BS 21 to the target BS 22 using an X2 interface, and at this time, the MME/S-GW 30 is not changed.

By the S1-based handover, the first bearer that has been established between the P-GW 40, MME/S-GW 30, source BS 21, and UE 10 is released, and a new second bearer is established between the P-GW 40, MME/S-GW 30, target BS 22, and UE 10.

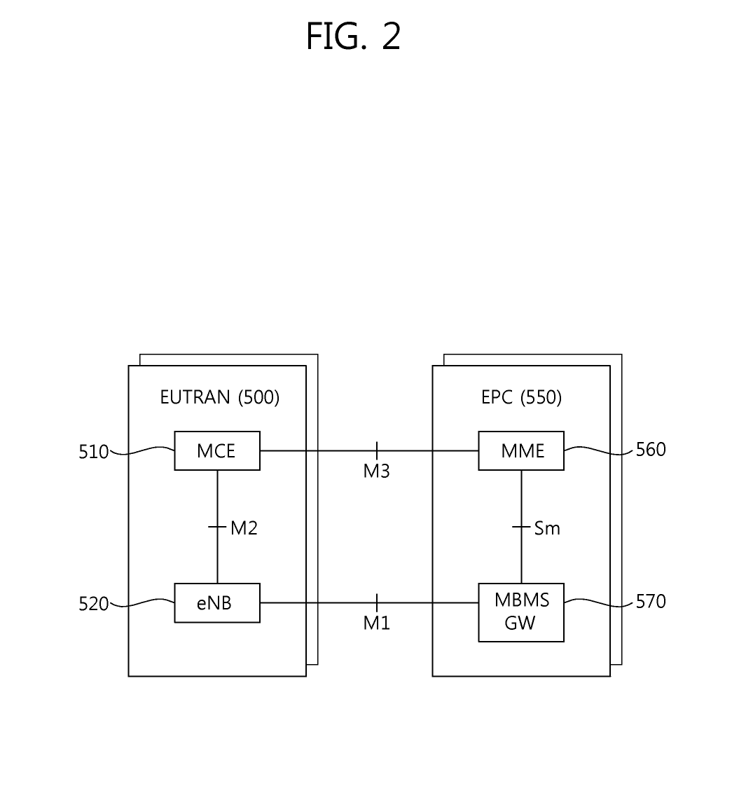

FIG. 2 is a view illustrating more specifically a core network architecture of an MBMS to which the present invention applies.

Referring to FIG. 2, the radio access network (EUTRAN, 500) includes a multi-cell coordination entity (hereinafter, “MCE”, 510) and a base station (eNB, 520). The MCE 510 is a main entity for controlling the MBMS and plays a role to perform session management, radio resource allocation or admission control of the base station 520. The MCE 510 may be implemented in the base station 520 or may be implemented independent from the base station 520. The interface between the MCE 510 and the base station 520 is called M2 interface. The M2 interface is an internal control plane interface of the radio access network 500 and MBMS control information is transmitted through the M2 interface. In case the MCE 510 is implemented in the base station 520, the M2 interface may be present only logically.

The EPC (Evolved Packet Core, 550) includes an MME 560 and an MBMS gateway (GW) 570. The MME 560 performs such operations as NAS signaling, roaming, authentication, selection of a PDN gateway and the S-GW, MME selection for handover by an MME change, accessibility to an idle mode UE, or AS security control.

The MBMS gateway 570 is an entity for transmitting MBMS service data and is positioned between the base station 520 and the BM-SC and performs MBMS packet transmission and broadcast to the base station 520. The MBMS gateway 570 uses a PDCP and IP multicast to transmit user data to the base station 520 and performs session control signaling for the radio access network 500.

The interface between the MME 560 and the MCE 510 is a control plane interface between the radio access network 500 and the EPC 550 and is called M3 interface. Control information related to MBMS session control is transmitted through the M3 interface. The MME 560 and the MCE 510 transmits, to the base station 520, session control signaling such as a session start/stop message for session start or session stop, and the base station 520 may inform the UE through a cell notification that the corresponding MBMS service has been started or stopped.

The interface between the base station 520 and the MBMS gateway 570 is a user plane interface and is called M1 interface.

Through the M2 interface, MBMS service data is transmitted. Meanwhile, in case a UE switches cells due to relocation while receiving an MBMS service, the reception of the MBMS service might not be continuously done. If the UE keeps performing the decoding operation in order to receive the MBMS service in such case, its battery may be wasted. A need exists for a scheme that allows a UE using an MBMS service to continuously receive the MBMS service upon handover without resource waste.

The source cell means a cell where a UE is currently receiving a service. The base station offering the source cell is referred to as source base station. The neighbor cell means a cell that is positioned adjacent to the source cell geographically or in a frequency band. The neighbor cell having the same carrier frequency as the source cell is referred to as intra-frequency neighbor cell, and the neighbor cell having a different carrier frequency from the source cell is referred to as inter-frequency neighbor cell. In other words, cells that use different frequencies from the source cell and are positioned adjacent to the source cell, as well as cells using the same frequency as the source cell, may be all called neighbor cells.

When a UE hands over from a source cell to an intra frequency neighbor cell, to such handover is called intra-frequency handover. On the other hand, a UE's handover from a source cell to an inter-frequency neighbor cell is called inter-frequency handover. The neighbor cell to which, upon handover, a UE goes over, is referred to as a target cell. The base station providing a target cell is called a target base station.

A source cell and a target cell may be provided by one base station or by different base stations from each other. Hereinafter, for ease of description, the source cell and the target cell are assumed to be provided by different base stations from each other, i.e., a source base station and a target base station. Accordingly, the source base station and the source cell may be used interchangeably, while the target base station and the target cell may be used interchangeably.

The MBMS service may be subjected to cell-based or geography-based management or localization. The MBMS service area is the term for denoting an area where a specific MBMS service is offered. For example, when the area where a specific MBMS service A is on is called MBMS service area A, the network may be left in the state of being transmitting MBMS service A. At this time, a UE may receive MBMS service A depending on the UE's capability. The MBMS service area may be defined in the point of view of service and application on whether a specific service is provided in a predetermined region.

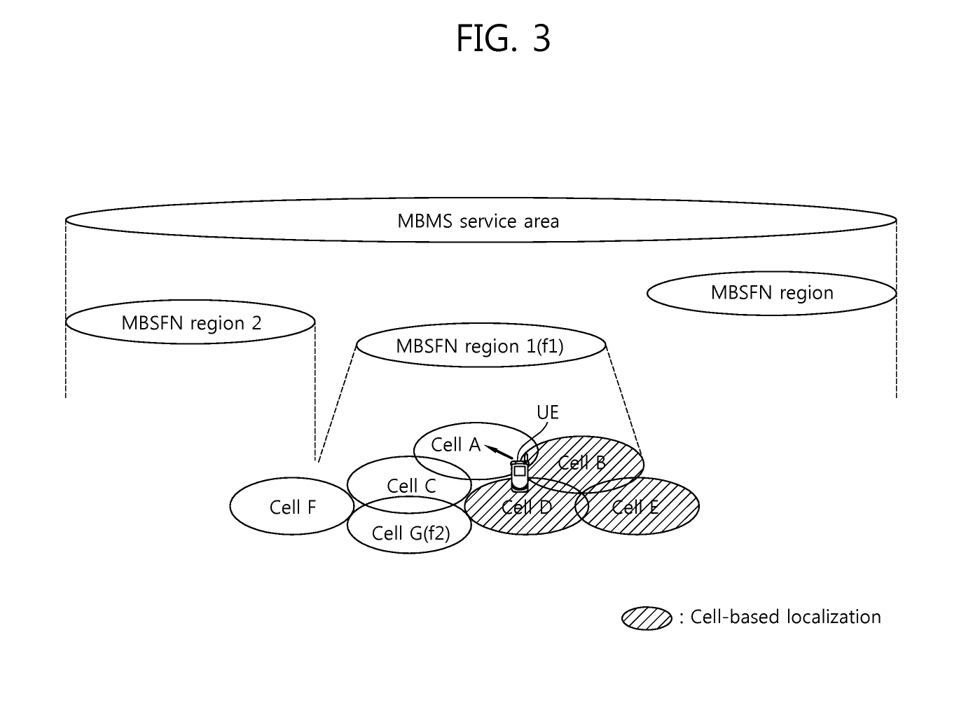

FIG. 3 illustrates a concept of a service scenario in an MBMS to which the present invention applies. This represents a scenario in which an MBMS location range is managed on a cell-basis.

Referring to FIG. 3, cell A, cell B, cell C, cell D, and cell D belong to MBSFN region 1, and cell F belongs to MBSFN region 2. Cell G is a non-MBSFN region cell and provides a service in a different frequency band f2. The MBSFN region means a region where to a specific MBMS service is provided in a single frequency band. For example, in the case of MBSFN region 1, an MBSFN sub-frame is allocated to frequency f1 to support specific MBMS service A. At this time, in the MBSFN region, an MBSFN sub-frame may be assigned to the same frequency f1, thereby backing up MBMS service A. For example, also in the case of MBSFN region 2, MBMS service A may be supported, but f3, different from the frequency resource, f1, in MBSFN region 1, may be used to support MBMS service A. In the same MBSFN region, even when a UE is on the move, the UE may receive the MBMS service based on the same MBMS configuration. Or, when there is a geographical change, also in the same MBSFN region, a different frequency may be used to offer a service.

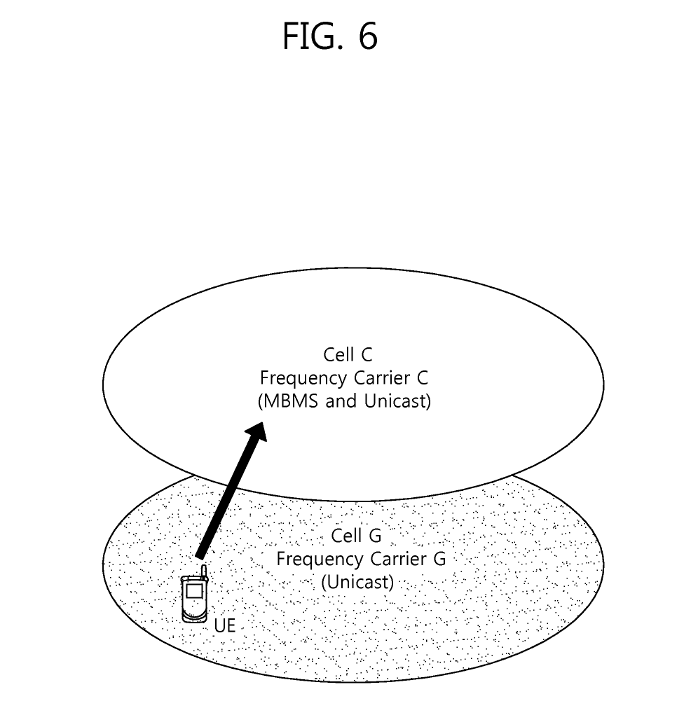

The MBMS location range is a concept used to perform such management as allows an MBMS service to be received through an MRB only in a specific area or location range even in the same MBSFN region, as compared with an MBMS service being able to be received through an MRB in all the cells in the MBSFN region. The MBMS location range may be managed on a cell-basis as shown in FIG. 6. For example, the MBMS location range of cell B, cell D, and cell E is localized in a cell-based manner (cell-based localization).

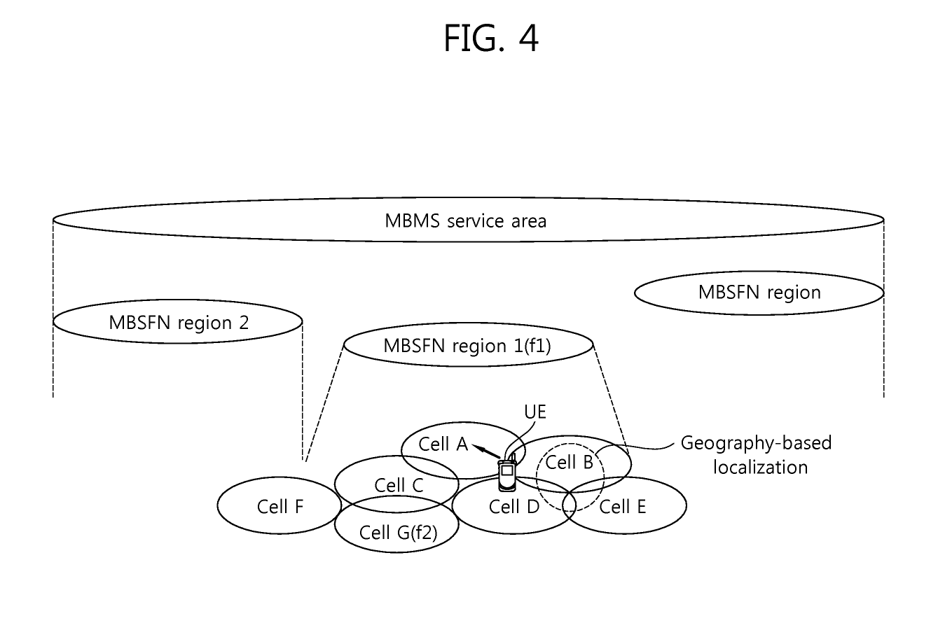

FIG. 4 illustrates another example of a service scenario in an MBMS to which the present invention applies.

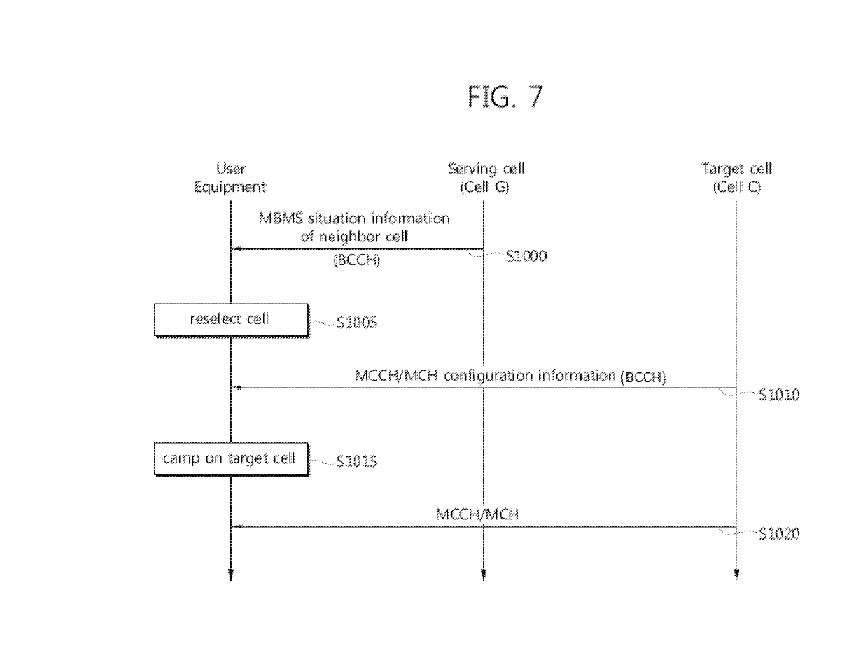

Referring to FIG. 4, the MBMS location range may be managed by a geography-based localization scheme, for example, a positioning scheme. This relates to a scenario in which a circular region (marked with dot lines) formed over cell B, cell D, and cell E manages the MBMS location range on a geography or exact location basis. Specifically, the scenario illustrated in FIG. 7 may be used to manage the MBMS location range using a positioning scheme.

A UE, when stayed in RRC idle mode, selects a cell that may provide possible services and adjusts itself to fit a control channel of the selected cell. Such process is referred to as “camp on cell.” If the comp on is done, the UE may register itself in a registration area. This is referred to as location registration (LR). A UE registers itself in the registration area regularly or when entering into a new tracking area (TA). The registration area refers to any area where a UE may roam without performing a location registration process.

The purposes of the UE, which stays in RRC idle state, proceeds with camp on, are as follows.

1) A UE receives system information from a PLMN (Public Land Mobile Network)

2) A UE, after initializing a call, first accesses a network through a control channel of a camped-on cell.

3) Receiving a paging message: in case a PLMN receives a call for a UE, the PLMN is aware of the registration area of the cell where the UE camped on. Accordingly, the PLMN may send out a paging message for the UE through the control channels of all the cells in the registration area. The UE has been already adjusted to fit the control channel of the camped-on cell, and thus, the UE may receive a paging message.

4) Receiving a cell's broadcasting message

If a UE cannot discover a cell proper to camp on or an SIM (Subscriber Identity Module) card is not inserted, or if the UE receives a specific response to a location registration request (for example, “illegal UE”), the UE attempts to camp on regardless of the PLMN and enters into a “limited service” state. In the limited service state, only emergency calls are possible.

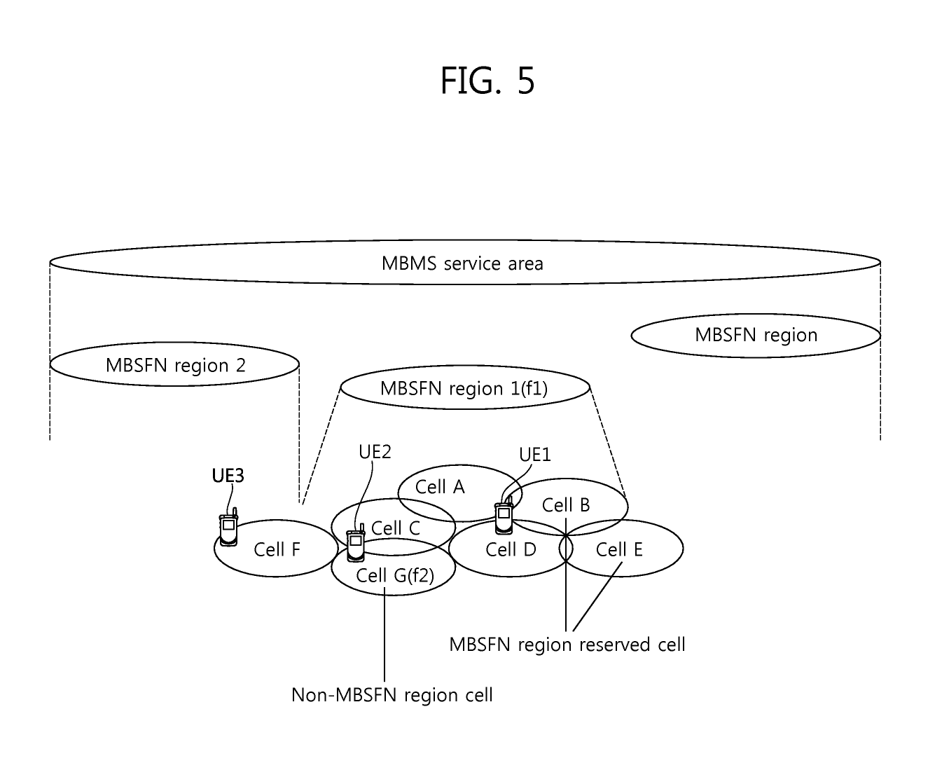

FIG. 5 illustrates another example of a service scenario in an MBMS to which the present invention applies.

Referring to FIG. 5, UE 1 (UE1) is currently in the state of receiving an MBMS service through an MRB in cell D. Cell G is a non-MBSFN region cell that does not support an MBMS service, and cell B or cell E is a reserved cell that is included in MBSFN region 1 but does not support an MBMS service through an MRB in a specific circumstance. For example, the distribution of UEs using an MBMS service concentrates on a specific region, so that very few UEs might receive the service through the MRB in cell B or cell E. In such case, supporting an MBMS service through an MRB is not preferable in terms of radio efficiency. Accordingly, an MBMS service, in the reserved cell, may be supported only to a specific UE through a dedicated bearer or point-to-point (ptp) service.

A shift of UE 1 may force UE 1 to receive the MBMS service through cell C and cell G. However, there might be, even in the same MBSFN region, a cell where the UE can keep receiving the MBMS service and a cell where the UE cannot keep receiving the MBMS service. Since cell C goes on transmitting an MBMS service through an MRB, UE 1, even after moved to cell C, may continue receiving the MBMS service. In contrast, cell G does not support an MBMS service, and UE 1 cannot keep receiving the MBMS service after moved over to cell G.

In a cell, for example, up to eight MBSFN regions may overlap each other. In one MBSFN region, one MBMS control channel (MCCH) may be configured. Accordingly, a maximum of eight MCCHs may be transmitted in one cell. Further, one MCCH may include 15 multicast channels (MCHs) and physical multicast channels (PMCHs). Thus, 15 MCHs/PMCHs may be configured in one MBSFN region. 28 MTCHs may be mapped to one MCH. The unit of one logical data flow may be referred to as an MBMS service.

UE 2 (UE2) stays in idle mode while camping on cell G. UE 2 may be in the state of being able to receive an MBMS service from a neighbor cell, cell C, but is positioned in cell G where no MBMS is offered and the MBMS-related information on cell C cannot be known. Accordingly, UE 2 cannot receive an MBMS service.

In order UE 2 to receive an MBMS service, neighbor cells need to be periodically checked so that an MBMS service which UE 2 is interested in is going on. For such purpose, it needs to be checked whether UE 2 receives, e.g., a broadcast channel (BCCH) and an MCCH and an MBMS is underway. However, prior to the MBMS service in which UE 2 is interested being initiated, such checking process ends up unnecessarily wasting UE resources, and thus, this process is meaningless.

UE 2 receives information on an MCCH channel that transmits MBMS-related information through BCCH information of a serving cell in order to receive an MBMS service. However, the serving cell provides only its MBMS-related information and does not provide a neighbor cell's MBMS-related information. Accordingly, UE 2 cannot obtain cell C's MBMS-related information nor can UE 2 receive an MBMS service offered by cell C. In order to receive an MBMS service in cell C, UE 2 needs to camp on cell C to identify a BCCH's SIB (system information block) 13 regarding cell C and receives MCCH-related information through the SIB13. This may deteriorate MBMS service continuity for UE 2 or MBMS reception efficiency.

In order to solve this, cell G needs to provide UE 2 with information on a neighbor cell where an MBMS service goes on. In other words, cell G needs to let UE 2 have information on an MBMS frequency, an MBMS carrier, a secondary serving cell (SCell), or downlink secondary component carrier (DL SCC) of a cell where an MBMS service is in process.

By way of example, in case UE 2 is in idle mode, cell G transmits MBMS frequency information on a neighbor cell through system information mapped to a BCCH. The MBMS-related information is transmitted through system information such as the SIB13. In such case, the SIB13, which is BCCH information provided by the serving cell, includes MBMS frequency information on a neighbor cell, as well as MCCH-related information. By doing so, cell G may provide UE 2 with a basic scheme that enables an MBMS-related service to be first received.

FIG. 6 is a concept view illustrating an MBMS carrier arrangement scenario to which the present invention applies.

Referring to FIG. 6, cell G has a carrier frequency of G, operates in a unicast manner, and is a non-MBSFN region cell (or briefly “non-MBMS cell”). In other words, cell G does not support an MBMS. A cell that does not support an MBMS does not service an MBMS through an MCH, point-to-multipoint (p-to-m) or MRB. Although a UE cannot be supported an MBMS service through an MRB, the UE can receive an MBMS service not through an MCH but through a DL-SCH via a p-t-p bearer. In contrast, cell C has a carrier frequency of C and may operate in a unicast manner, alongside an MBMS.

Assume that when it comes to an MBMS's service continuity, a UE camps on cell G to receive an MBMS service. Cell G is in the situation where the cell cannot perform transmission through an MCH and is not included in an MBSFN region. However, the UE may receive a BCCH from cell G.

There are two options when a UE in RRC idle mode receives an MBMS. First, the UE, after entry into RRC connection mode in cell G, receives an MBMS service mapped with a DL-SCH through a p-t-p bearer. According to this scheme, the UE should separately perform a process of entering into the RRC connection mode and should use a DL-SCH in order to receive an MBMS. Thus, such scheme is inefficient. Further, the UE maintaining the RRC connection mode only for the purpose of receiving an MBMS service is an unnecessary operation.

Second, a UE receives an MBMS service through a p-t-m bearer of cell C while maintaining the RRC idle mode. For this, the UE needs to analyze the MBMS service situation of cell C in the camped-on cell G. In order to be aware of the MBMS service situation, the UE monitors neighbor cells including cell C continuously or periodically while camped on cell G. Monitoring neighbor cells includes the process of the UE analyzing the frequency at which an MBMS service is provided in the neighbor cells or the process of analyzing whether an MBMS service in which the UE is interested is provided in the neighbor cells. Or, such monitoring includes the process of the UE analyzing the frequency at which an MBMS service is provided in the neighbor cells and the process of analyzing whether an MBMS service in which the UE is interested is provided in the neighbor cells. After monitoring the neighbor cells in cell G, the UE may receive an MBMS service in cell C by cell reselection.

The UE monitoring all of the neighbor cells without any reference may be, in most cases, unnecessary before an MBMS service is started. Accordingly, cell G transmits an MBMS frequency list (MBMSFreqList) of a neighbor cell, listing carriers or frequencies for providing an MBMS service in the neighbor cell to the UE. Or, cell G transmits an MBMS frequency list of the neighbor cell and an MBMS service indicator to the UE.

Accordingly, the UE may first perform monitoring on the MBMS carrier or frequency indicated by the MBMS frequency list of the neighbor cell. That is, the problem of the UE unnecessarily monitoring an additional frequency can be addressed. Further, the UE may first carry out monitoring on the MBMS carrier or frequency that provides a type of MBMS service in which the UE is interested.

FIG. 7 is a flowchart illustrating a method of transmitting MBMS situation information regarding a neighbor cell providing an MBMS service according to an embodiment of the present invention.

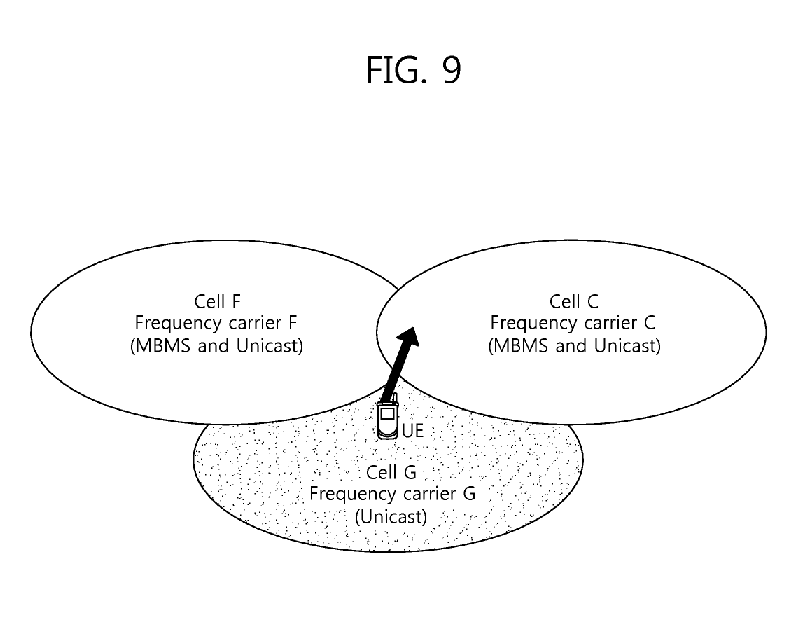

Referring to FIG. 7, it is assumed that the serving cell is cell G in FIG. 9 and the target cell is cell C in FIG. 9. The carrier frequency of the serving cell is G, is a non-MBSFN cell, and provides a unicast service. The target cell has a carrier frequency of C, and provides an MBMS and a unicast service. The UE (UE) is in RRC idle mode and is currently camping on the serving cell, and travels over to the target cell.

The serving cell maps the SIB13 including the MBMS situation information of the neighbor cell to a BCCH and transmits the mapped result to the UE (S1000). The MBMS situation information includes an MBMS frequency list of the neighbor cell or MBMS service indicator. Or, the MBMS situation information includes both the MBMS frequency list of the neighbor cell and MBMS service indicator. The MBMS frequency list of the neighbor cell indicates the frequency or frequency of a target cell, i.e., cell C, where the UE intends to receive an MBMS service. For instance, an example of the SIB13 including the MBMS frequency list of the neighbor cell is as shown in the following table:

TABLE 1

-- ASN1START
SystemInformationBlockType13 ::=SEQUENCE {
mbsfn-AreaInfoListMBSFN-AreaInfoList,
notificationConfigMBMS-NotificationConfig,
mbms-FrequencyList1MBMS-FrequencyList
lateNonCriticalExtensionOCTET STRINGOPTIONAL,-- Need OP
. . .
}
MBMS-FrequencyList ::= SEQUENCE {
carrierFreq1ARFCN-ValueEUTRAOPTIONAL,-- Need OP
carrierFreq2ARFCN-ValueEUTRAOPTIONAL,-- Need OP
. . .
}

Referring to Table 1, the information element SIB13 includes information required to obtain MBMS control information associated with one or more MBSFN regions. For example, SIB13 includes information elements such as mbsfn-AreaInfoList, notificationConfig, mbms-FrequencyList, lateNonCriticalExtension. mbms-FrequencyList is a neighbor cell's MBMS frequency list (MBMSFreqList) and this information element lists carrier frequencies that provide an MBMS service in the neighbor cell, such as carrier frequency 1 (carrierFreq1), carrier frequency 2 (carrierFreq2), . . . . The value indicating a carrier frequency is information element ARFCN-ValueEUTRA as shown in Table 2 below, and the ARFCN-ValueEUTRA is used to indicate absolute radio frequency channel number (ARFCN) that may apply to a bi-directional carrier frequency, e.g., on downlink and uplink or in TDD (Time Division Duplex).

TABLE 2

-- ASN1START
ARFCN-ValueEUTRA ::=INTEGER (0..maxEARFCN)
-- ASN1STOP

Meanwhile, the UE might not receive MBMS-related information or may receive only MBMS information except MBSFN-related information. The MBMS-related information the UE desires to receive may be transmitted through an MBSFN region where the UE does not or cannot receive the information.

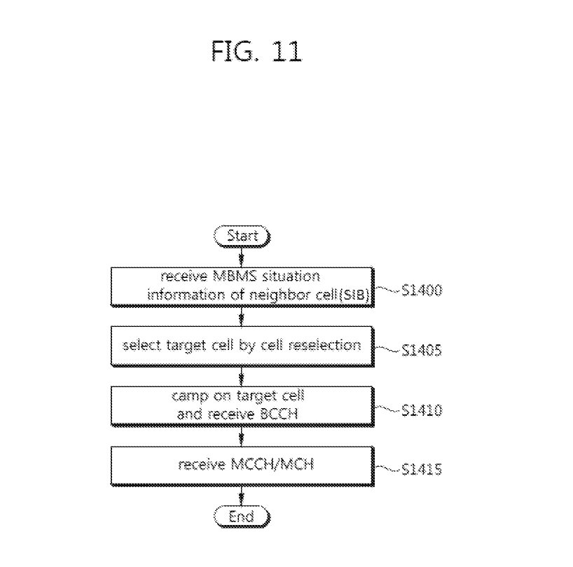

The MBMS service indicator is used to inform the UE of whether an MBMS service starts to be transmitted in the MBSFN region when the UE receives an MBMS service in cell C. For this, although belonging to a non-MBSFN region, the serving cell (cell G) transmits an MBMS service indicator to the UE. For example, as shown in FIG. 11, while the UE camps on cell G, neighbor cells are cell F and cell C. Cell G transmits an MBMS service indicator in order to inform the UE of the type of the MBMS service provided at the frequency of cell C. For example, the MBMS service indicator may denote that cell F provides MBMS service A, and cell C provides MBMS service B. The MBMS service indicator may be configured in various schemes.

As an example, the MBMS service indicator includes information on one frequency carrier and a list for the type of the MBMS service that is being provided by the frequency carrier. This is the case where in one MBSFN region an MBMS is transmitted by one MBMS frequency carrier. By way of example, as shown in Table 3, the MBMS service to indicator provides a list of MBMS frequency carrier C and the type of MBMS services provided in MBMS frequency carrier C.

TABLE 3

| MBMS frequency carrier information | Type of MBMS service |
|---|---|
| C | service1, service2, service3, . . . |

As another example, the MBMS service indicator indicates information on one frequency carrier and type of all MBMS services that may be provided in the frequency carrier, and whether per MBMS service, a corresponding MBMS service is being provided. This is as shown in Table 4.

TABLE 4

| MBMS frequency | MBMS | MBMS service | Whether to |
|---|---|---|---|
| carrier information | service type | identifier | provide (On/Off) |
| C | Service 1 | TMGI1 | On |
| | Service 2 | TMGI2 | Off |
| | Service 3 | TMGI3 | On |
| | . . . | . . . | . . . |
| | Service n | TMGIn | On |

Referring to Table 4, in contrast to Table 3 in which MBMS frequency carrier information and MBMS service-related content, which is being provided in a corresponding frequency carrier, are only included and transmitted, Table 4 lets the UE know in detail whether each MBMS service is being provided. Here, the temporary mobile group identity (TMGI) is an identifier for telling the type of an MBMS service.

As another example, the MBMS service indicator indicates information on multiple frequency carriers, type of all MBMS services that may be provided in each frequency carrier, and whether per MBMS service a corresponding MBMS service is being provided. This is as shown in Table 5.

TABLE 5

| MBMS frequency | MBMS | MBMS service | Whether to |
|---|---|---|---|
| carrier information | service type | identifier | provide (On/Off) |
| C | Service 1 | TMGI1 | On |
| | Service 2 | TMGI2 | Off |
| | Service 3 | TMGI3 | On |
| | . . . | . . . | . . . |
| | Service n | TMGIn | On |
| F | Service 1 | TMGI1 | Off |
| | Service 2 | TMGI2 | On |
| | Service 3 | TMGI3 | Off |
| | . . . | . . . | . . . |
| | Service m | TMGIm | On |

Referring to Table 5, in case there are multiple neighbor cells (cell C and cell F) adjacent to cell G, and each neighbor cell provides an MBMS service, the MBMS service indicator may in detail inform the UE of frequency carrier information on cell C and cell F, MBMS service type, MBMS service identifier and whether each MBMS service is being provided.

The UE conducts cell reselection (S1005). After the UE selects some cell through a cell selecting process, the strength of signals between the UE and the base station may vary due to changes in the UE's mobility or radio environment. Thus, in case the quality of the selected cell is deteriorated, the UE may select other cell providing better quality. As such, in case a cell is selected again, a cell providing better signal quality than the currently selected cell is selected. This process is called cell reselection. The cell reselection process, in light of the quality of radio signals, puts its basic purpose in picking up a cell offering the best quality to the UE.

Cell reselection can be done in the following scheme. By way of example, the UE first monitors a neighbor cell that may support an MBMS service based on the MBMS frequency list. The UE then reselects any one neighbor cell. At this time, one MBMS frequency carrier may be indicated or a number of MBMS frequency carriers may be sequentially listed by the MBMS frequency list. If there is only one MBMS frequency carrier, the UE may first monitor the MBMS frequency carrier and may conduct cell reselection. If there are several MBMS frequency carriers, the UE may monitor the frequency carriers of each neighbor cell according to the listed order.

As another example, the UE first monitors and reselects a neighbor cell that provides an MBMS service of the type the UE intends to receive based on the MBMS service indicator because the UE may grasp the type of MBMS services provided in the neighbor cell from the MBMS service indicator and may be aware of the neighbor cell where an MBMS service in which the UE is interested is supported.

The target cell transmits MCCH configuration information indicating the configuration of an MCCH or MCH configuration information indicating the configuration of an MCH to the UE via a BCCH (S1010). The UE camps on the target cell (S1015). Here, steps S1010 and S1015 may be reversible in order and may be performed at the same time. That is, when an MIB, SIB1 and SIB2 are received conceptually can be deemed as the camp-on state, and may be determined as continuing to receive necessary SIB information thereafter.

The UE receives an MCCH based on the MCCH configuration information, verifies settings related to reception of an MBMS service, and receives an MBMS in the target cell based on the MCH configuration information (S1020).

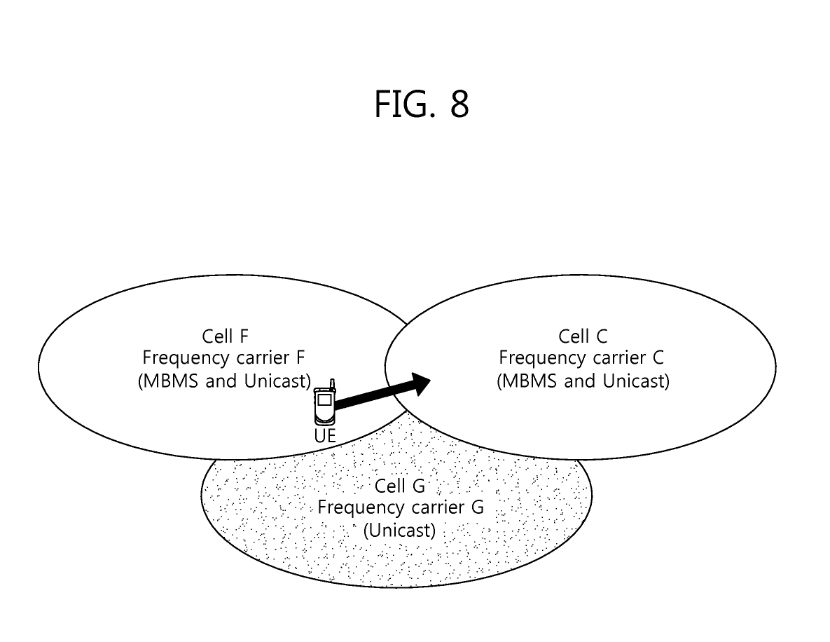

The procedure illustrated in FIG. 7 may equally apply to the MBMS carrier arrangement scenario illustrated in FIG. 8 or 9.

FIG. 8 is a concept view illustrating an MBMS carrier arrangement scenario to which the present invention applies.

Referring to FIG. 8, the UE is in RRC idle mode and is camping on cell F. Cell F may provide both a unicast and MBMS service, and thus, the UE might be able to be receiving an MBMS service through carrier F in cell F. An MBMS service that interests the UE may be transmitted through cell C. The UE cannot be aware of the situation of an MBMS provided from cell C. The UE may monitor and even receive an MBMS service offered through an MBMS frequency carrier in cell C while camping on cell F, according to capability. However, in normal cases, the UE needs to decode the BCCH in cell C and periodically monitor the MCCH in order to exactly grasp the MBMS situation of cell C which the UE has an interest in. This is why the UE cannot be aware of whether its desired MBMS service is provided through cell C or cell F. However, periodically using the UE's resources for grasping the MBMS situation of a neighbor cell although an MBMS service is not initiated may be a waste.

Accordingly, e.g., whether an MBMS service which the UE has an interest in begins should be signaled through cell F where the UE is camping on, and for such purpose, an MBMS service indicator is used.

FIG. 9 is another concept view illustrating an MBMS carrier arrangement scenario to which the present invention applies.

Referring to FIG. 9, the UE is in RRC idle mode and is camping on cell G. Cell G provides a unicast service, and thus, the UE may be in the state of not receiving an MBMS service. An MBMS service in which the UE has an interest may be transmitted through cell C. The UE cannot be aware of an MBMS situation provided in cell C. The UE may monitor and even receive an MBMS service provided through an MBMS frequency carrier in cell C while camping on cell G according to its capability. However, in normal cases, the UE needs to decode a BCCH in cell C and periodically monitor an MCCH in order to exactly grasp the MBMS situation of cell C that interests the UE, while camping on cell G. This is why the UE does not have any clue on whether the UE's desired MBMS service is offered through cell C or cell F. However, periodically using the UE's resources for grasping the MBMS situation of a neighbor cell although an MBMS service is not initiated is a waste.

Accordingly, e.g., whether an MBMS service in which the UE has an interest begins should be signaled through cell G which the UE is camping on, and for such purpose, an MBMS service indicator is used. By using an MBMS service indicator, the UE, despite not checking if its MBMS service of interest is provided per neighbor cell, may perform cell reselection to select cell C that is offering an MBMS service of interest.

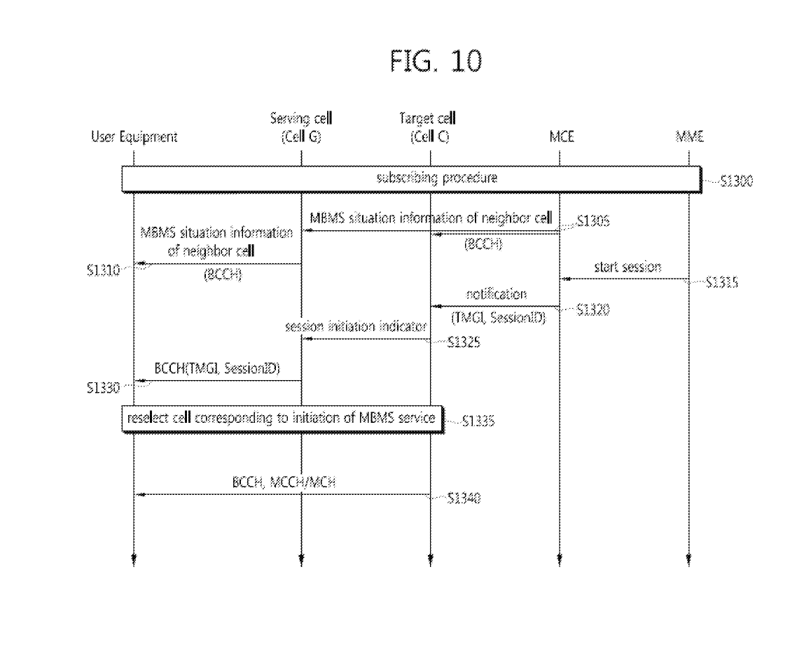

FIG. 10 is a flowchart illustrating a method of transmitting MBMS situation information regarding a neighbor cell offering an MBMS service according to another embodiment of the present invention.

Referring to FIG. 10, a UE informs an MME that there is an MBMS service of interest and that the UE desires to receive the corresponding MBMS service. By doing so, the MME may have the sense that the UE is supposed to receive a specific MBMS service. This is referred to as a joining procedure (S1300).

The MCE transmits, to serving cell G and target cell C, MBMS situation information of a neighbor cell, including an MBMS frequency list and/or MBMS service indicator (S1305). Serving cell G and target cell C receive the MBMS situation information of the neighbor cell. Here, serving cell G may be a non-MBSFN cell that does not belong to an MBSFN region, and target cell C may be an MBSFN cell that belongs to an MBSFN region.

Serving cell G maps system information including the MBMS situation information of the neighbor cell to a BCCH and transmits the mapped result to the UE (S1310). The UE, although receiving the MBMS situation information of the neighbor cell transmitted from serving cell G, cannot be aware of whether a session for the MBMS service to which the UE has subscribed is initiated.

The MME transmits, to the MCE, a session initiation indicator for the UE's subscribed MBMS service (S1315).

When receiving the session initiation indicator of the MBMS service, the MCE sends a notification to serving cell G and target cell C that the corresponding MBMS service is being initiated (S1320). The notification includes a TMGI for identifying the MBMS service and a session ID that is an identifier of the session. When receiving the notification, cells get ready for initiating an MBMS service. The MCE, after session initiation, performs operations such as radio resource allocation for providing an MBMS service. Serving cell G is a cell that presently cannot back up an MBMS service. Since serving cell G cannot support an MBMS, the MCE might not immediately provide a session initiation indicator to the serving cell. In such case, target cell C may transmit a session initiation indicator to serving cell G (S1325). At this time, serving cell G and target cell C may be cells that are provided from different base stations from each other or from the same base station. In contrast, in case the MCE immediately provides a session initiation message to serving cell G, step S1325 may be skipped.

Serving cell G transmits the TMGI and session ID of the MBMS service to the UE via a BCCH in order to inform that the MBMS service in which the UE has an interest is initiated in target cell C (S1330). For instance, serving cell G may send MBMS situation information to the UE via a BCCH, with information on MBMS services whose sessions have been initiated included in the MBMS situation information.

The UE verifies through the TMGI and session ID that its subscribed MBMS service goes on in target cell C and travels over to target cell C by cell reselection (S1335). In case there is no session initiation indicator in the existing subscribed MBMS service, the frequency for the existing subscribed MBMS service is continuously monitored, and if an MBMS service is verified to go on, cell reselection may be conducted thereafter. As such, upon cell reselection, the UE identifies whether an MBMS service of interest begins, and thus, unnecessary cell reselection can be prevented from being carried out.

The UE receives an MCCH based on MCCH configuration information, verifies settings related with reception of an MBMS service over an MCCH, and receives an MBMS in target cell C based on the MCH configuration information (S1340).

FIG. 11 is a flowchart illustrating a UE's operation of receiving MBMS situation information regarding a neighbor cell according to an embodiment of the present invention.

Referring to FIG. 11, the UE receives MBMS situation information of a neighbor cell from a serving cell (S1400). Here, the UE is in RRC idle mode and is currently camping on the serving cell, and may be in the middle of shifting to a target cell. The serving cell is a non-MBSFN cell and provides a unicast service. The target cell is an MBSFN cell that provides an MBMS and a unicast service. The MBMS situation information includes an MBMS frequency list of a neighbor cell or MBMS service indicator. Or, the MBMS situation information includes both an MBMS frequency list of a neighbor cell and an MBMS service indicator. The MBMS frequency list of the neighbor cell indicates the frequency or carrier of a target cell where the UE desires to receive an MBMS service. The MBMS situation information may have such formats as are shown in, e.g., Table 1, 3, 4, or 5. The MBMS situation information is system information and may be transmitted, mapped with a BCCH.

The UE selects a target cell by cell reselection (S1405). The cell reselection can be performed by the following method. As an example, the UE first monitors a neighbor cell that may support an MBMS service based on the MBMS frequency list. The UE then reselects a target cell that is a neighbor cell. At this time, one MBMS frequency carrier may be indicated by the MBMS frequency list or a number of MBMS frequency carriers may be sequentially listed. If there is only one MBMS frequency carrier, the UE may first monitor the MBMS frequency carrier and perform cell reselection. If there are several MBMS frequency carriers, the UE may monitor frequency carriers of each neighbor cell according to the order in which the carriers are listed.

As another example, the UE first monitors and reselects a neighbor cell that provides the same type of MBMS service as the UE desires to receive based on the MBMS service indicator. This is why the UE may grasp the type of MBMS services provided by a neighbor cell from the MBMS service indicator and be aware of a neighbor cell which supports an MBMS service in which the UE has an interest.

The UE camps on the target cell and receives from the target cell through a BCCH MCCH configuration information indicating the configuration of an MCCH or MCH configuration information indicating the configuration of an MCH (S1410).

The UE receives the MCCH based on the MCCH configuration information, identifies settings related to reception of an MBMS service over the MCCH, and receives from the target cell an MBMS service mapped to the MCH indicated by the MCH configuration information (S1415).

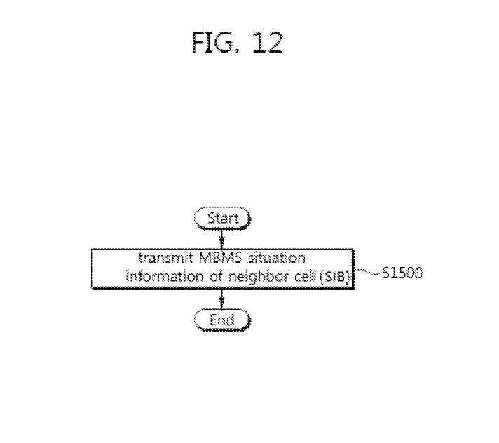

FIG. 12 is a flowchart illustrating the operation of a serving base station transmitting MBMS situation information regarding a neighbor cell according to an embodiment of the present invention.

Referring to FIG. 12, the serving base station transmits SIB13 including MBMS situation information of a neighbor cell to the UE, mapped to a BCCH (S1500). Here, the MBMS situation information of the neighbor cell may have such a format as is shown in, e.g., Table 1, 3, 4, or 5.

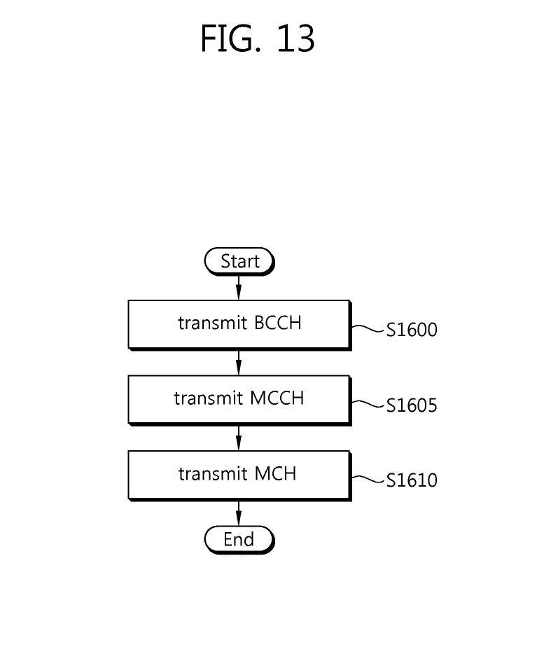

FIG. 13 is a flowchart illustrating the operation of a target base station transmitting MBMS situation information regarding a neighbor cell according to an embodiment of the present invention.

Referring to FIG. 13, the target base station maps MCCH configuration information indicating the configuration of an MCCH to a BCCH and MCH configuration information indicating the configuration of an MCH to an MCCH and transmits the mapped result to the UE (S1600). The UE is a UE camped-on to the target base station, i.e., a UE selected by performing cell reselection on the target cell provided by the target base station. The target base station transmits MCH configuration information to the UE through an MCCH indicated by the MCCH configuration information (S1605) and transmits an MBMS service mapped to the MCH indicated by the MCH configuration information to the UE (S1610).

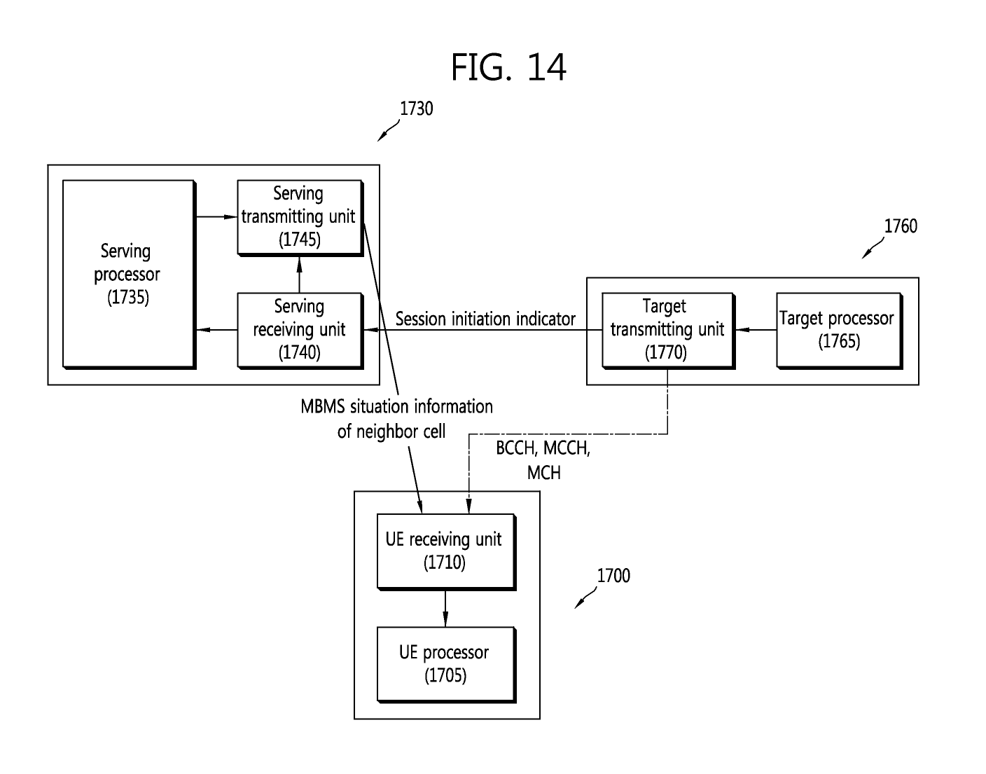

FIG. 14 is a block diagram illustrating a UE, a serving base station, and a target base station according to an embodiment of the present invention.

Referring to FIG. 14, the UE 1700 includes a UE processor 1705 and a UE receiving unit 1710. The serving base station 1730 includes a serving processor 1735, a serving receiving unit 1740, and a serving transmitting unit 1745. The target base station 1760 includes a target processor 1765 and a target transmitting unit 1770.

The UE processor 1705 stores MBMS situation information of a neighbor cell, received by the UE receiving unit 1710, MCCH configuration information mapped to a BCCH, and MCH configuration information, analyzes the fields of each information element, and performs cell reselection. For example, the UE processor 1705 first monitors a neighbor cell that may support an MBMS service based on an MBMS frequency list. The UE processor 1705 then reselects any one neighbor cell. At this time, one MBMS frequency carrier may be indicated by the MBMS frequency list or a number of MBMS frequency carriers may be sequentially listed. If there is only one MBMS frequency carrier, the UE processor 1705 may first monitor the MBMS frequency carrier and may perform cell reselection. If there are several MBMS frequency carriers, the UE processor 1705 may monitor the frequency carriers of each neighbor cell according to the listed order.

As another example, the UE processor 1705 first monitors and reselects a neighbor cell that provides the same type of MBMS service as the UE 1700 desires to receive based on an MBMS service indicator. This is why the UE processor 1705 may grasp the type of MBMS services provided by a neighbor cell through an MBMS service indicator and may be aware of a neighbor cell that supports an MBMS service in which the UE has an interest.

The UE receiving unit 1710 receives MBMS situation information of a neighbor cell from the serving base station 1730 and receives a BCCH, MCCH, and MCH from the target base station 1760. The MBMS situation information of the neighbor cell may be included in system information, for example, SIB13, and may be transmitted, mapped with a BCCH.

The serving processor 1735 performs an operation regarding an MBMS session based on a session initiation indicator received by the serving receiving unit 1740. Further, the serving processor 1735 generates MBMS situation information of a neighbor cell and sends the generated MBMS situation information to the serving transmitting unit 1745. The MBMS situation information includes one of an MBMS frequency list of a neighbor cell and an MBMS service indicator. Or, the MBMS situation information includes both the MBMS frequency list of the neighbor cell and the MBMS service indicator. The MBMS frequency list of the neighbor cell indicates the frequency or carrier of a target cell where the UE 1700 desires to receive an MBMS service. The MBMS situation information may have such a format as is shown in, e.g., Table 1, 3, 4, or 5.

The serving transmitting unit 1745 transmits MBMS situation information of a neighbor cell, generated by the serving processor 1735 to the UE 1700. The serving receiving unit 1740 receives a session initiation indicator from the target base station 1760 and sends it to the serving processor 1735.

The target processor 1765 generates information elements mapped to a BCCH, MCCH, and MCH. For example, the target processor 1765 generates a TMGI or session ID, system information, and MCCH configuration information, mapped to the BCCH, MCH configuration information mapped to the MCCH, or an MBMS service mapped to the MCH. Or, the target processor 1765 generates a session initiation indicator indicating the onset of an MBMS service in which the UE 1700 has an interest.

The target transmitting unit 1770 transmits a session initiation indicator to the serving base station 1730 and transmits the BCCH, MCCH, and MCH to the UE 1700.

The above-described functions may be all performed by a processor, such as a microprocessor, controller, microcontroller, or ASIC (Application Specific Integrated Circuit) according to software or program codes coded to perform the functions. It will be apparent to those of ordinary skill in the art from the description of the present invention to design, develop and implement the codes.

Although embodiments of the present invention have been described, it will be understood by those of ordinary skill in the art that various changes may be made thereto without departing from the scope of the present invention as defined by the following claims.

1. A method of receiving control information on a Multimedia Broadcast Multicast Service (MBMS) by a user equipment (UE), the method comprising:
receiving MBMS situation information from a serving cell through a first broadcast channel, the MBMS situation information including information on at least one frequency carrier of at least one neighbor cell adjacent to the serving cell and an indicator for identifying an MBMS service supported by the at least one frequency carrier;
selecting a cell by monitoring at least one frequency supporting the MBMS service based on the MBMS situation information; and
receiving at least one MBMS service in the selected cell.

2. The method of claim 1, wherein selecting the cell includes reselecting the cell by first monitoring a neighbor cell that supports an MBMS service which the UE desires to receive based on the information on the at least one frequency carrier, or by first monitoring a neighbor cell providing the MBMS service based on the indicator.

3. The method of claim 1, wherein the indicator further includes a temporary mobile group identity (TMGI) identifying a type of the MBMS service and information indicating whether the MBMS service is provided.

4. The method of claim 1, further comprising receiving MBMS control channel (MCCH) configuration information including a configuration of an MCCH through a second broadcast channel in the selected cell.

5. A user equipment (UE) to receive control information regarding a Multimedia Broadcast Multicast Service (MBMS), the UE comprising:
a UE receiving unit to receive MBMS situation information from a serving cell through a first broadcast channel, the MBMS situation information including information on at least one frequency carrier of at least one neighbor cell adjacent to the serving cell and an indicator for identifying an MBMS service supported by the at least one frequency carrier; and
a UE processor to reselect a cell by monitoring at least one frequency supporting the MBMS service based on the MBMS situation information,
wherein the UE receiving unit receives at least one MBMS service in the selected cell.

6. The UE of claim 5, wherein the UE processor reselects the cell by first monitoring a neighbor cell that supports an MBMS service which the UE desires to receive based on the information on the at least one frequency carrier, or by first monitoring a neighbor cell providing the MBMS service based on the indicator.

7. The UE of claim 5, wherein the UE receiving unit receives MBMS control channel (MCCH) configuration information including a configuration of an MCCH through a second broadcast channel in the selected cell.

8. The UE of claim 5, wherein the UE receiving unit receives the indicator further including a temporary mobile group identity (TMGI) identifying a type of the MBMS service and information indicating whether the MBMS service is provided.

9. A method of transmitting control information regarding a Multimedia Broadcast Multicast Service (MBMS) performed by a base station, the method comprising:
transmitting, at a serving base station, MBMS situation information to a user equipment (UE) through a first broadcast channel on a serving cell, the MBMS situation information including information on at least one frequency carrier of at least one neighbor cell adjacent to the serving cell where a UE camps on and an indicator for identifying an MBMS service supported by the at least one frequency carrier;
transmitting, at a target base station, MBMS control channel (MCCH) configuration information to the UE through a second broadcast channel on the at least one neighbor cell;
transmitting, at the target base station, multicast channel (MCH) configuration information to the UE through an MCCH indicated by the MCCH configuration information; and
transmitting, at the target base station, to the UE an MBMS service mapped to an MCH indicated by the MCH configuration information.

10. The method of claim 9, wherein the indicator for identifying the MBMS service further includes a temporary mobile group identity (TMGI) identifying a type of the MBMS service and information indicating whether the MBMS service is provided.

11. The method of claim 9, wherein the serving cell is not included in a Multimedia Broadcast multicast service Single Frequency Network (MBSFN) region, and the at least one neighbor cell is included in the MBSFN region.

12. A base station to transmit control information regarding a Multimedia Broadcast Multicast Service (MBMS), the base station comprising:
a serving processor to generate MBMS situation information, the MBMS situation information including information on at least one frequency carrier of at least one neighbor cell adjacent to the serving cell where a user equipment (UE) camps on and an indicator for identifying an MBMS service supported by the at least one frequency carrier;
a serving transmitting unit to transmit the MBMS situation information to the UE through a first broadcast channel on the serving cell; and
a serving receiving unit to receive a session initiation indicator indicating that a session for at least one type of MBMS service is initiated from a target base station providing the at least one neighbor cell.

13. The base station of claim 12, wherein the serving cell is not included in a Multimedia Broadcast multicast service Single Frequency Network (MBSFN) region, and the at least one neighbor cell is included in the MBSFN region.

14. The base station of claim 12, wherein the serving processor generates the indicator including a temporary mobile group identity (TMGI) identifying a type of the MBMS service and information indicating whether the MBMS service is provided.
